(19) United States
(12) Patent Application Publication
(10) Pub. No.: US 2007/0058215 A1
(43) Pub. Date: Mar. 15, 2007

(54) Scanning apparatus

(75) Inventor: Jung-yun Won, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/368,522

(22) Filed: Mar. 7, 2006

(30) Foreign Application Priority Data
Sep. 14, 2005 (KR) 2005-85777

(51) Int. Cl. H04N 1/04

(52) U.S. Cl. 358/474; 358/497

(57) ABSTRACT

A scanning apparatus including a scanner main body provided with a document sheet stand; a scan unit being movably installed in the scanner main body for scanning an image of a document sheet placed on the document sheet stand; a driving unit to drive the scan unit; a locking unit to lock/unlock a motion of the scan unit; and a control section to control a driving of the locking unit in response to a scan signal. The scan unit is automatically locked/unlocked by the locking unit.

### CROSS-REFERENCE TO RELATED APPLICATIONS

This application claims the benefit of Korean Application No. 2005-85777, filed Sep. 14, 2005, in the Korean Intellectual Property Office, the disclosure of which is incorporated herein by reference.

### BACKGROUND OF THE INVENTION

1. Field of the Invention

An aspect of the present invention relates to a scanning apparatus, and, more particularly, to a scanning apparatus that is provided in a composite device or a copy machine to scan an image of document sheet.

2. Description of the Related Art

In general, a composite device is a device to scan an image of a document sheet and to store, print or transmit the scanned image. To this end, the composite device is provided with a scanning apparatus to scan the image of document sheet.

As shown in FIG. 1, such a scanning apparatus comprises a scanner main body 10, a scan unit 20 and a locking member 40. The scanner main body 10 is provided with a flat plate shaped transparent stand 11 on which a document sheet is placed. This document sheet stand 11 is selectively opened by a cover (not shown). The scan unit 20 is movably installed in the scanner main body 10 to scan an image of a document sheet that is placed on the document sheet stand 11. Here, the scan unit 20 is reciprocated in the horizontal direction in FIG. 1 by a timing belt 32 supported and rotated by a pair of driving pulleys 31. As such, the scan unit 20 is moved between a home location H, at which the scan unit 20 waits to receive a scan signal, and a scan area S, at which the scan unit 20 scans an image of the document sheet in response to an inputted scan signal.

In order to prevent the scan unit 20 from being moved and damaged when the scanner main body 10 is moved, the locking member 40 fixes the scan unit 20 in place at the home location H. This locking member 40 protrudes through an opening 12 formed in the scanner main body 10, and an end of the locking member is combined with the scan unit 20. The locking member 40 may be manually operated by the user (operator).

In such scanning apparatuses, however, since the locking member 40 is manually operated, the user may not properly recognize a locking/unlocking state of the scan unit 20. Accordingly, the scanning apparatus may have problems such as a scan signal being inputted with the scan unit 20 being in a locking state and, where the locking member 40 does not lock the scan unit 20, when the scanner main body 10 is moved, the scan unit 20 may also be moved and damaged.

Also, another problem in the scanning apparatus is that exterior dust enters an interior of the scanner main body 10 through the opening 12 formed for the locking member 40.

### SUMMARY OF THE INVENTION

An aspect of the present invention is to solve at least the above and/or other problems and disadvantages and to provide at least the advantages described below. Accordingly, an aspect of the present invention is to provide a scanning apparatus which may be used safely by locking/unlocking automatically a scan unit.

In order to achieve the above-described and/or other aspects of the present invention, there is provided a scanning apparatus comprising a scanner main body provided with a document sheet stand; a scan unit being movably installed in the scanner main body to scan an image of a document sheet placed on the document sheet stand; a driving unit to drive the scan unit; a locking unit to lock/unlock a motion of the scan unit; and a control section to control a driving of the locking unit in response to a scan signal.

The locking unit selectively locks a driving of the driving unit. In an embodiment of the invention, the driving unit comprises a pair of driving pulleys and a belt member being connected to the scan unit and supported rotatably by the driving pulleys. The locking unit selectively restricts a rotation of the belt member and comprises a locking member to restrict a rotation of the belt member and an operating section to operate the locking member in response to a signal inputted from the control section. The belt member is provided with a hooking section onto which the locking member is selectively hooked and the hooking section comprises a plurality of hooking grooves formed on the belt member in the longitudinal direction at regular intervals.

The locking member is a lever being capable of moving between a locking position at which the lever is hooked on and fixed to the hooking groove to lock the scan unit and an unlocking position at which the lever is removed from the hooking groove to unlock the scan unit. Also, the locking unit further comprises an elastic member to elastically bias the locking member.

According to another embodiment, the locking unit selectively locks a rotation of the driving pulley. The driving pulley is provided with a hooking section onto which the locking member is selectively hooked and the hooking section comprises a plurality of hooking grooves formed on an end of the driving pulley with which the belt member is not contacted.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a plane view showing schematically the conventional scanning apparatus;

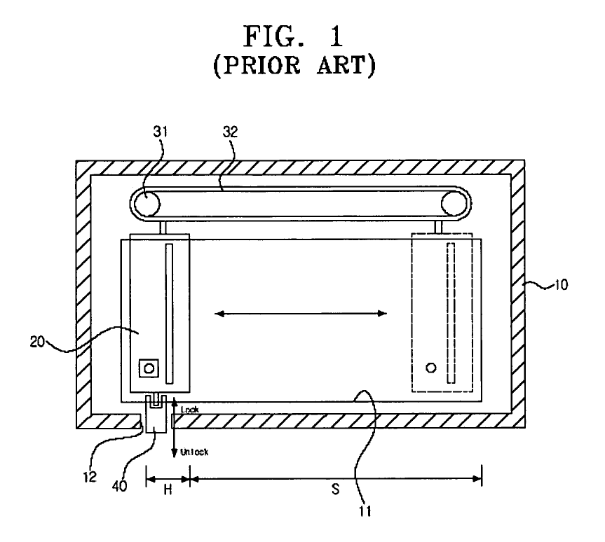

FIG. 2 and FIG. 3 are plane views showing schematically a structure and an operation of a scanning apparatus according to one embodiment of the present invention;

FIG. 4 is a perspective view showing schematically a scanning apparatus according to another embodiment of the present invention; and

FIG. 5 is a sectional view taken along the line V-V in FIG. 4

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

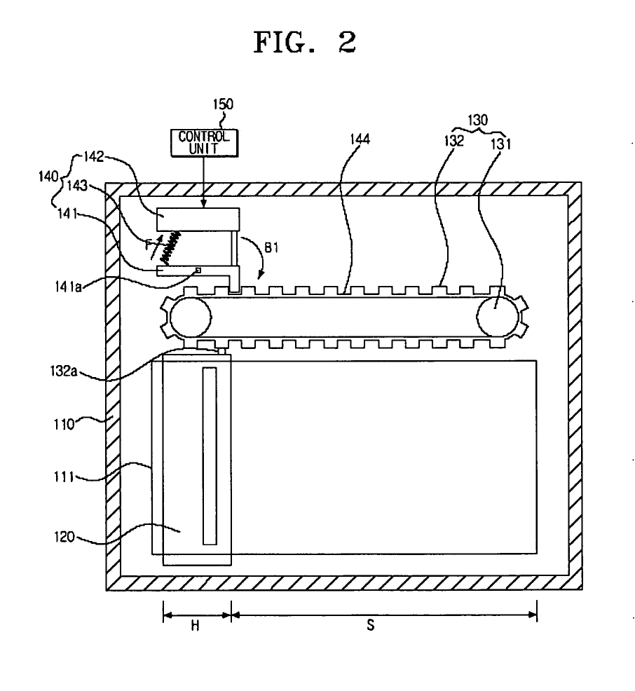

As shown in FIG. 2 and FIG. 3, a scanning apparatus according to an embodiment of the present invention comprises a scanner main body 110, a scan unit 120, a driving unit 130, a locking unit 140 and a control section 150. The scanner main body 110 is provided with a flat plate shaped transparent stand 111 on which a document sheet is placed. Here, the document sheet stand 111 is selectively opened by a cover (not shown).

The scan unit 120 is moveably installed in the scanner main body 110 to be positioned to scan an image of a document sheet placed on the document sheet stand 111. Here, the scan unit 120 may be moved between a home location H, at which the scan unit waits to receive a scan signal and a scan area S (spaced from the home location H), at which the scan unit may scan an image of a document sheet in response to an externally inputted scan signal.

The scan unit 120 comprises an optical sensor such as a contact image sensor (CIS) or a charge coupled device (CCD) which irradiates light toward the document sheet and senses light reflected from the document sheet. A technical structure of the scan unit 120 may be understood from the known art, and so the detailed description thereon is omitted.

The driving unit 130 drives the scan unit 120 and comprises a pair of driving pulleys 131 and a belt member 132 that is supported on the driving pulleys 131. The belt member 132 is connected to the scan unit 120 through a connecting member 132a, and allows the scan unit 120 to be reciprocatably driven in the right and left directions of the drawing. A technical structure of a conventional timing belt may be applied to this belt member 132.

The locking unit 140 locks and unlocks an ability of the scan unit 120 to move. The locking unit 140 is constructed so as to selectively lock a drive of the driving unit 130 and comprises a locking member 141, an operating section 142 and an elastic member 143. The locking member 141 selectively restricts a rotation of the belt member 132. To this end, hooking grooves 144 are formed on the belt member 132 at regular intervals in the longitudinal direction. The locking member 141 is hooked and fixed selectively on any one of these hooking grooves 144.

According to an embodiment of the invention, the locking member 141 comprises a lever, the lever being installed on the scanner main body 110 at a hinge 141a, such that the lever is rotatable in the direction B1 or B2. Here, as shown in FIG. 2, the locking member 141 is rotated in the B1 direction and hooks and fixes onto the hooking groove 144. Thus, the locking member is located at a locking position at which the locking member locks a drive of the scan unit 120. Also, as shown in FIG. 3, the locking member 141 may rotate in the B2 direction and deviate from the hooking groove 144. Thus, the locking member is located at an unlocking position at which the locking member unlocks a drive of the scan unit 120.

The operating section 142 operates the locking member 141 according to the signal inputted from the control section 150. According to an embodiment of the invention, the operating section 142 may comprise a solenoid which converts a mechanical signal into an electrical signal that is used by the operating section 142. The elastic member 143 is installed between the operating section 142 and the locking member 141 and provides an elastic force F by which the locking member 141 is biased in one direction, that is, toward the locking position. To put it concretely, as shown in FIG. 2, the elastic member 143 elastically biases the locking member 141 toward the locking position to make the locking member be maintained in the locking state. That is, the elastic member 143 provides an elastic force F by which the locking member 141 located at the unlocking position is returned to the locking position.

The control section 150 controls a drive of the locking unit 140 in response to the externally transmitted scan signal. In more detail, where no scan signal is inputted, the control section 150 controls the locking member 141 to position the locking member at the locking position, as shown in FIG. 2, and, when the scan signal is inputted, the control section 150 positions the locking member 141 at the unlocking position, as shown in FIG. 3, to allow for a driving of the scan unit 120.

While waiting for a scan signal, as shown in FIG. 2 the scan unit 120 is located at the home location H. At this time, the control section 150 controls the locking unit 140 to locate the locking unit 140 at the locking position. In more detail, if the control section 150 does not transmit the scan signal to the operating section 142, the locking member 141 is rotated in the B1 direction by an elastic force F of the elastic member 143. At this time, the locking member 141 hooks and fixes onto the hooking groove 144 formed on the belt member 132. To this end, a motion of the scan unit 120 generated by the driving unit 130 is locked by the locking unit 140.

As shown in FIG. 3, once receiving the scan signal, the control section 150 inputs the scan signal into the operating section 142. The operating section 142 rotates the locking member 141 in the B2 direction with a force which is larger than an elastic force F of the elastic member 143 which biases the locking member 141 in the B1 direction. The rotated locking member 141 escapes from the hooking groove 144 and is then located at the unlocking position at which a locking state of the belt member 132 is released.

In this unlocked state the scan unit 120 is allowed to escape from the home location H by a driving of the driving unit 130 and is moved into the scan area S. Thus, the scan unit 120 is able to scan an image of the document sheet placed on the document sheet stand 111. In addition, once a scan operation of the scan unit 120 is completed, the scan unit 120 is again located and locked at the home location H to await the next scan signal. At this time, the locking member 141 again locks a drive of the scan unit 120.

On the other hand, where a transmission of the scan signal is interrupted due to a break of the power supply during the scanning of an image in the scan area S by the scan unit 120, the locking member 141 is rotated to the locking position to lock a driving of the scan unit 120. Due to such construction, the locking unit 140 may automatically lock/unlock a driving of the scan unit 120 according to the externally inputted scan signal.

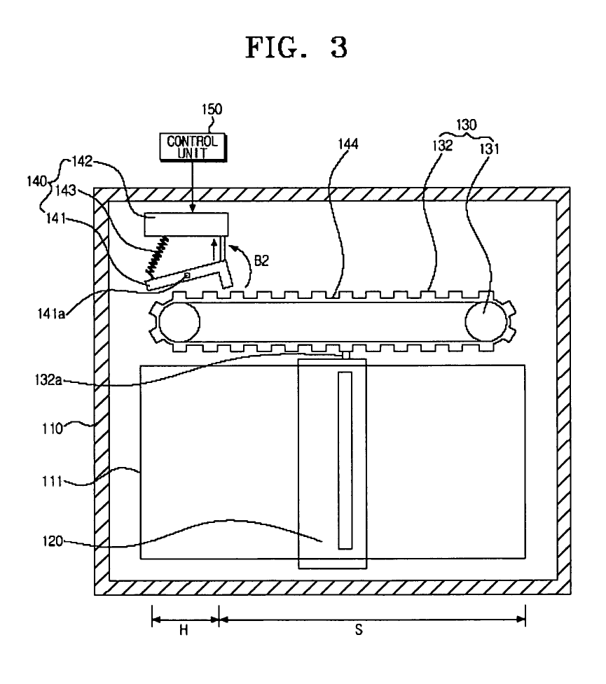

FIG. 4 shows the scanning apparatus according to another embodiment of the present invention. As shown in FIG. 4, the scanning apparatus comprises the scanner main body 110, the scan unit 120, the driving unit 130, a locking unit 140′ and the control section 150. Here, technical structures of the scanner main body 110, the scan unit 120, the driving unit 130 and the control section 150 are similar to those of the scanner main body 110, the scan unit 120, the driving unit 130 and the control section 150 of the embodiment shown in FIG. 2 and FIG. 3, and so these components will have the same reference numerals and a detailed description thereon is omitted.

According to this embodiment, a locking member 141′ of the locking unit 140′ selectively locks a rotation of the driving pulley 131 of the driving unit 130. To this end, hooking grooves 144′ are formed on one of a pair of the driving pulleys 131. The locking member 132, located at the locking position, may be hooked on and fixed to any of these hooking grooves 144.

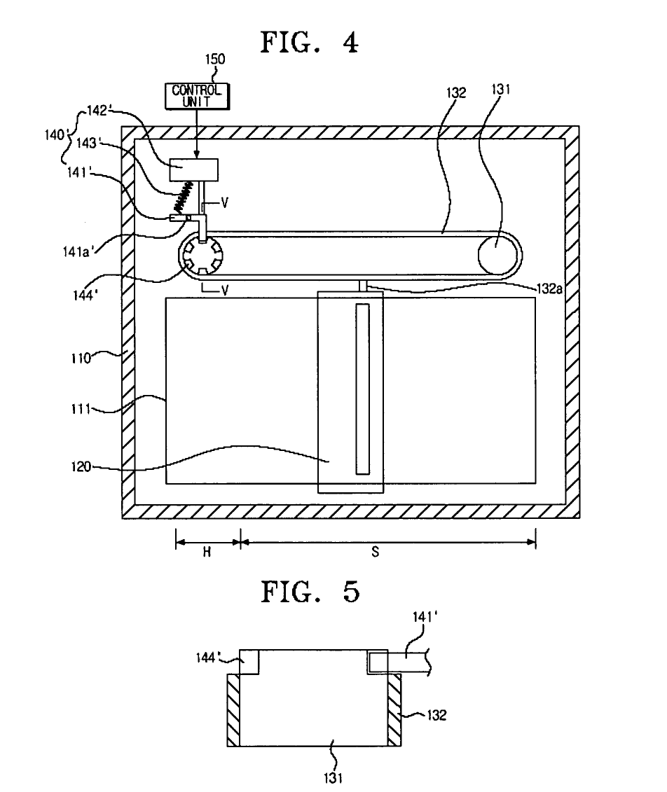

Here, for a smooth drive (movement) of the belt member 132, the hooking grooves 144′ formed on the driving pulley 131 are formed in a region in which the driving pulley and the belt member 132 are not in contact with each other. That is, as shown in FIG. 5, the hooking groove 144′ is formed at an upper side of the driving pulley 131 with which the belt member 132 is not contacted, and so the locking member 141 is fixed at the locking position. Here, it is noted various modifications of this embodiment are possible, such as the belt member 142′ having the hooking groove formed at a lower side thereof. In this example, except for the fact that the locking member 141′ selectively locks a driving of the driving pulley 131 to lock/unlock a driving of the scan unit 120, the technical structure of this embodiment is same as that of the embodiment described previously, and so the detailed description thereon is omitted.

In the above described embodiments, although an elastic member 143 (143) is provided between the locking member 141 (141′) and the operating section 142 (142′) to bias the locking member 141 (141′), the present invention may comprise various modifications. For example, the operating section 142 (142′) may directly rotate the locking member 141 (141′) without requiring an elastic member 143 (143) being provided between the locking member 141 (141′) and the operating section 142 (142′) of the locking unit 140 (140′).

According to the aspects of the present invention, as described above, by providing the locking unit which automatically locks/unlocks a driving of the scan unit according to whether the scan signal is inputted or not, the various problems caused by a user not recognizing a locking/unlocking state of the scan unit may be solved. Also, since the locking unit is installed in the scanner main body, there is no need to form an additional opening on the scanner main body. Thus, preventing exterior dust from entering the apparatus through the opening is possible. Consequently, the present invention may provide a scanning apparatus which may be safely used and which may minimize an occurrence of failure.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A scanning apparatus, comprising
a scanner main body provided with a document sheet stand;
a scan unit being movably installed in the scanner main body to scan an image of a document sheet placed on the document sheet stand;
a driving unit to drive the scan unit;
a locking unit to lock/unlock a motion of the scan unit; and
a control section to control a driving of the locking unit in response to whether a scan signal is inputted.

2. The scanning apparatus according to claim 1, wherein the locking unit selectively locks the driving of the driving unit.

3. The scanning apparatus according to claim 2, wherein the locking unit comprises a locking member to selectively lock the driving of the driving unit and an operating section to operate the locking member according to a signal inputted from the control section.

4. The scanning apparatus according to claim 3, wherein the locking member comprises a lever to occupy and move between a locking position at which the lever restricts the driving unit and an unlocking position at which the lever releases the driving unit.

5. The scanning apparatus according to claim 4, wherein the locking unit comprises an elastic member to elastically bias the locking member toward the driving unit.

6. The scanning apparatus according to claim 1, wherein the driving unit comprises a pair of driving pulleys and a belt member, the belt member being connected to the scan unit and rotatably supported by the driving pulleys, and wherein the locking unit restricts a rotation of the belt member when the locking unit locks the motion of the scan unit.

7. The scanning apparatus according to claim 6, wherein the locking unit comprises:
a locking member to restrict a rotation of the belt member; and
an operating section to operate the locking member in response to a signal inputted from the control section.

8. The scanning apparatus according to claim 7, wherein the belt member comprises a hooking section onto which the locking member is hooked when the locking unit locks the motion of the scan unit.

9. The scanning apparatus according to claim 8, wherein the hooking section comprises hooking grooves formed across the belt member along a length of the belt member at regular intervals.

10. The scanning apparatus according to claim 9, wherein the locking member comprises a lever to occupy and move between a locking position at which the lever is hooked onto the hooking groove to lock the scan unit and an unlocking position at which the lever is removed from the hooking groove to unlock the scan unit.

11. The scanning apparatus according to claim 10, wherein the locking unit further comprises an elastic member to elastically bias the locking member.

12. The scanning apparatus according to claim 1, wherein the driving unit comprises a pair of driving pulleys and a belt member, the belt member being connected to the scan unit and rotatably supported by the driving pulleys, and wherein the locking unit selectively locks a rotation of one of the driving pulleys.

13. The scanning apparatus according to claim 12, wherein the locking unit comprises a locking member to restrict a rotation of the driving pulley and an operating section to operate the locking member in response to a signal inputted from the control section.

14. The scanning apparatus according to claim 12, wherein the driving pulley comprises a hooking section onto which the locking member is selectively hooked.

15. The scanning apparatus according to claim 14, wherein the hooking section comprises hooking grooves formed on an end of the driving pulley to which the belt member does not contact.

16. The scanning apparatus according to claim 15, wherein the locking member comprises a lever to occupy and move between a locking position at which the lever is hooked onto the hooking groove to lock the scan unit and an unlocking position at which the lever is removed from the hooking groove to unlock the scan unit.

17. The scanning apparatus according to claim 16, wherein the locking unit further comprises an elastic member to elastically bias the locking member.

18. A scanning apparatus, including a main body having a sheet stand and a scan unit to scan an image of a sheet placed on the sheet stand, the apparatus comprising:
a locking unit to occupy and move between a locked position at which the locking unit prevents a movement of the scan unit and an unlocked position at which the locking unit does not prevent a movement of the scan unit; and
a control section to cause the locking unit to move to and occupy the locked position when a scan signal to scan the image of the sheet is not inputted and to move to and occupy the unlocked position when the scan signal is inputted.

19. The apparatus according to claim 18, further comprising a driving unit to drive the movement of the scan unit, wherein the locking unit locks a driving of the driving unit.

20. The scanning apparatus according to claim 19, wherein the locking unit comprises:
a locking member to selectively lock the driving of the driving unit; and
an operating section to operate the locking member according to a signal inputted from the control section.

21. The scanning apparatus according to claim 20, wherein the locking member comprises a lever to occupy and move between a locking position at which the lever restricts the driving unit and an unlocking position at which the lever releases the driving unit.

22. The scanning apparatus according to claim 21, wherein the locking unit comprises an elastic member to elastically bias the locking member toward the driving unit.

23. The scanning apparatus according to claim 19, wherein the driving unit comprises a pair of driving pulleys and a belt member, the belt member being connected to the scan unit and rotatably supported by the driving pulleys, and wherein, when the locking unit occupies the locked position, the locking unit selectively restricts a rotation of the belt member.

24. The scanning apparatus according to claim 23, wherein the locking unit comprises:
a locking member to restrict a rotation of the belt member; and
an operating section to operate the locking member in response to a signal inputted from the control section.

25. The scanning apparatus according to claim 24, wherein the belt member comprises a hooking section onto which the locking member is hooked when the locking unit occupies the locked position.

26. The scanning apparatus according to claim 25, wherein the hooking section comprises hooking grooves formed across the belt member along a length of the belt member at regular intervals.

27. The scanning apparatus according to claim 26, wherein the locking member comprises a lever to occupy and move between a locking position at which the lever is hooked onto the hooking groove to lock the scan unit and an unlocking position at which the lever is removed from the hooking groove to unlock the scan unit.

28. The scanning apparatus according to claim 27, wherein the locking unit further comprises an elastic member to elastically bias the locking member.

29. The scanning apparatus according to claim 19, wherein the driving unit comprises a pair of driving pulleys and a belt member, the belt member being connected to the scan unit and rotatably supported by the driving pulleys, and wherein, when the locking unit occupies the locked position, the locking unit selectively locks a rotation of one of the driving pulleys.

30. The scanning apparatus according to claim 29, wherein the locking unit comprises:
a locking member to restrict a rotation of the driving pulley; and
an operating section to operate the locking member in response to a signal inputted from the control section.

31. The scanning apparatus according to claim 29, wherein the driving pulley comprises a hooking section onto which the locking member is hooked when the locking unit occupies the locked position.

32. The scanning apparatus according to claim 31, wherein the hooking section comprises hooking grooves formed on an end of the driving pulley to which the belt member does not contact.

33. The scanning apparatus according to claim 32, wherein the locking member comprises a lever to occupy and move between a locking position at which the lever is hooked onto the hooking groove to lock the scan unit and an unlocking position at which the lever is removed from the hooking groove to unlock the scan unit.

34. The scanning apparatus according to claim 33, wherein the locking unit further comprises an elastic member to elastically bias the locking member.

35. A scanning apparatus, including a main body having a sheet stand and a scan unit to scan an image of a sheet placed on the sheet stand, the apparatus comprising:
a locking unit formed entirely in the main body to occupy and move between a locked position at which the locking unit prevents a movement of the scan unit and an unlocked position at which the locking unit does not prevent a movement of the scan unit; and
a control section to cause the locking unit to move to and occupy the locked position when a scan signal to scan the image of the sheet is not inputted and to move to and occupy the unlocked position when the scan signal is inputted.
